(19) United States
(12) Patent Application Publication
(10) Pub. No.: US 2009/0043954 A1
(43) Pub. Date: Feb. 12, 2009

(54) Information Recording/Playback Apparatus and Memory Control Method

(76) Inventor: Hiroaki TACHIBANA, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/164,432

(22) Filed: Jun. 30, 2008

(30) Foreign Application Priority Data
Aug. 8, 2007 (JP) 2007-207248

(51) Int. Cl. G06F 12/06

(52) U.S. Cl. 711/105; 711/E12.083

(57) ABSTRACT

This information recording/playback apparatus has a memory for storing data and which includes a plurality of storage cells configured from a capacitor for accumulating charge. When an issue interval time for issuing a read/write command to an arbitrary storage cell is shorter than a threshold time for retaining a charge amount for the arbitrary storage cell to read correct data, a dummy read command for simulatively reading data stored in storage cells other than the arbitrary storage cell is issued to storage cells other than the arbitrary storage cell, and dummy read processing is executed for replenishing charge in the capacitor configuring storage cells other than the arbitrary storage cell.

### CROSS-REFERENCES

This application relates to and claims priority from Japanese Patent Application No. 2007-207248, filed on Aug. 8, 2007, the entire disclosure of which is incorporated herein by reference.

### BACKGROUND

The present invention generally relates to an information recording/playback apparatus and a memory control method, and in particular can be suitably applied to an information recording/playback apparatus using a semiconductor memory.

It is common practice to use a DRAM (Dynamic Random Access Memory), which is a semiconductor memory, in an information recording/playback apparatus when temporarily storing data such as external visual and audio information in the internal main storage of the apparatus.

The minimum unit of storage cells in the DRAM is configured from a capacitor and an adjacent switch transistor, and data is stored by accumulating charge in the capacitor.

With a DRAM, since the charge will decrease when a given period of time lapses due to reasons such as the current flowing even when the transistor is turned off, it is necessary to periodically perform rewriting (hereinafter referred to as “refresh”) in order to continue retaining the charge.

Since a DRAM needs to be refreshed in given intervals, Japanese Patent Laid-Open Publication No. 2000-235789 disclosed technology for preventing wasted power caused by excessive refresh operations by counting a shorter cycle than the set refresh cycle, and performing the refresh operation by excluding addresses in the DRAM to which the reading and writing of data were performed in short cycles.

In addition, Japanese Patent Laid-Open Publication No. 2006-269029 discloses technology for shortening the processing time and preventing the deterioration in the memory width of the DRAM even when the refresh operation and the standard memory access overlap by issuing an access processing command embedded with a refresh processing command to addresses in the DRAM that need to be refreshed.

### SUMMARY

When adopting the auto refresh method as one method of performing the refresh operation, the refresh processing is automatically performed by issuing an auto refresh command to all storage cells in the DRAM.

Nevertheless, if the interval of issuing a data read/write command is shorter than the interval of issuing the auto refresh command to an arbitrary address in the storage cell, there is no need to perform the refresh operation since the charge is already accumulated.

Thus, an object of the present invention is to propose an information recording/playback apparatus and a memory control method capable of realizing low power consumption by performing control so that the refresh operation is not performed to storage cells that do not need to be refreshed.

In order to achieve the foregoing object, the present invention provides an information recording/playback apparatus comprising a memory for storing data and which includes a plurality of storage cells configured from a capacitor for accumulating charge. When an issue interval time for issuing a read/write command to an arbitrary storage cell is shorter than a threshold time for retaining a charge amount for the arbitrary storage cell to read correct data, a dummy read command for simulatively reading data stored in storage cells other than the arbitrary storage cell is issued to storage cells other than the arbitrary storage cell, and dummy read processing is executed for replenishing charge in the capacitor configuring storage cells other than the arbitrary storage cell.

The present invention additionally provides a memory control method of an information recording/playback apparatus comprising a memory for storing data and which includes a plurality of storage cells configured from a capacitor for accumulating charge. This memory control method comprises, when an issue interval time for issuing a read/write command to an arbitrary storage cell is shorter than a threshold time for retaining a charge amount for the arbitrary storage cell to read correct data, a step of issuing a dummy read command for simulatively reading data stored in storage cells other than the arbitrary storage cell to storage cells other than the arbitrary storage cell, and a step of executing dummy read processing for replenishing charge in the capacitor configuring storage cells other than the arbitrary storage cell.

According to the present invention, it is possible to seek the low power consumption of the information recording/playback apparatus by performing control so that the refresh operation is not performed to storage cells that do not need to be refreshed.

### DESCRIPTION OF DRAWINGS

FIG. 1 is a block diagram showing the overall configuration of an information recording/playback apparatus according to an embodiment of the present invention;

FIG. 2 is a conceptual diagram showing the internal configuration of a DRAM memory according to an embodiment of the present invention;

FIG. 3 is a block diagram for the CPU to perform memory control according to an embodiment of the present invention;

FIG. 4 is a timing chart for the CPU to perform memory control according to an embodiment of the present invention;

FIG. 5 is a timing chart for the CPU to perform auto refresh according to an embodiment of the present invention;

FIG. 6 is a flowchart of the dummy read processing according to an embodiment of the present invention;

FIG. 7 is a graph showing the relationship of the charge amount and time in the storage cell according to an embodiment of the present invention;

FIG. 8 is an explanatory diagram showing the area setting in the DRAM memory according to an embodiment of the present invention;

FIG. 9 is a flowchart of the dummy read execution processing according to an embodiment of the present invention; and

FIG. 10 is an explanatory diagram showing a dummy read command according to an embodiment of the present invention.

### DETAILED DESCRIPTION

An embodiment of the present invention is now explained with reference to the attached drawings.

### (1) Configuration of Information Recording/Playback Apparatus

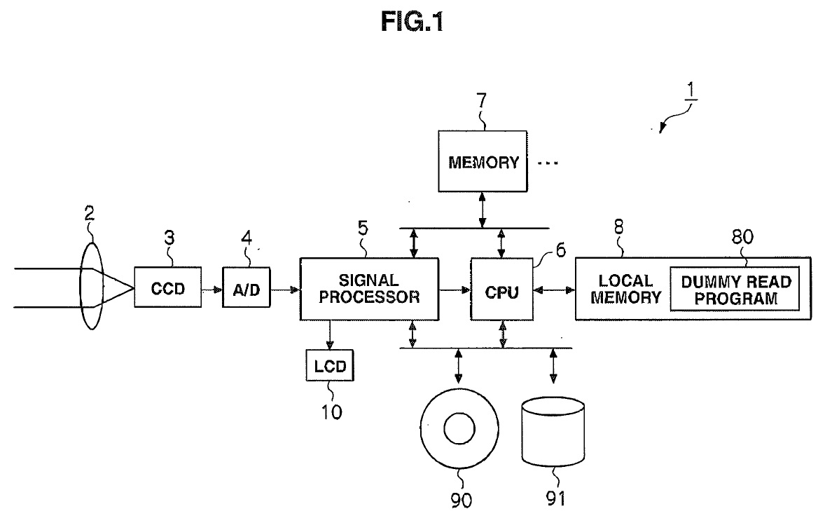

FIG. 1 shows the overall information recording/playback apparatus 1 according to the present embodiment.

The information recording/playback apparatus 1 obtains an image information signal by imaging a subject image from a photographing optical system 2 on a CCD (image sensor) 3, thereafter digitizing the image information signal with an A/D converter 4, and converting the digitized image signal into image data with a signal processor 5. Subsequently, the information recording/playback apparatus 1 temporarily stores the image data in the DRAM memory 7, reads the image data from the DRAM memory 7 upon recording such image data, converts the image data into a recording medium format with the signal processor 5, and thereafter records the image data in a recording medium such as an optical disk 90 or a hard disk drive 91. During playback, the information recording/playback apparatus 1 reads the image data from the recording medium and converts it into the original image data with the signal processor 5, and thereafter displays the image data on a display screen such as an LCD (Liquid Crystal Display) 10.

Moreover, when the information recording/playback apparatus 1 obtains an audio information signal from a microphone (not shown), it converts this into audio data with the signal processor 5. The converted audio data is processed as with the image data.

A CPU 6 governs the control of the foregoing processing, and controls the respective components and governs the control of the overall apparatus. The CPU 6 also reads a dummy read program 80 described later from a local memory 8, and performs simulative read processing to a certain area in the DRAM memory 7.

### (2) Memory Control

The present invention is characterized in that, when an issue interval time for issuing a data read/write command is shorter than an issue interval time for issuing a refresh command to an area configured from arbitrary storage cells in the DRAM memory 7, the CPU 6 performs dummy read processing of simulatively reading data in substitute for performing the refresh operation to areas other than the area configured from the arbitrary storage cells.

Before explaining the method of realizing the foregoing feature, how the CPU 6 performs memory control is explained.

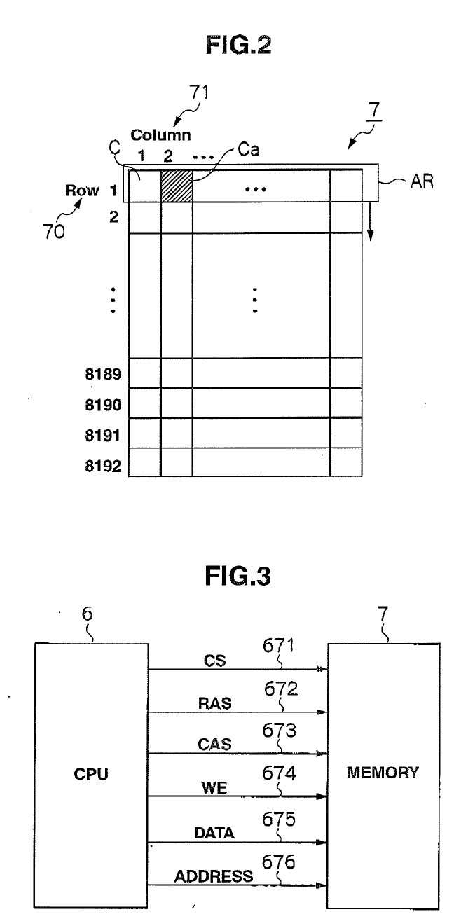

As shown in FIG. 2, the storage cells C in the DRAM memory 7 are arranged in a grid pattern, and a single storage cell C is identified by the CPU 6 designating a vertical row address 70 and a horizontal column address 71. Image data and audio data are read from and written into the identified storage cell C.

Specifically, as shown in FIG. 3, the storage cell C is identified by the CPU 6 sending a signal to the DRAM memory 7. The CPU 6 sends to the DRAM memory 7 a CS (Chip Select) signal 671 for identifying a specific DRAM memory 7 among a plurality of DRAM memories 7, an RAS (Row Address Strobe) signal 672 for designating the row address 70, a CAS (Column Address Strobe) signal 673 for designating the column address 71, a WE (Write Enable) signal 674 for issuing a read/write command, a DATA 675 for sending and receiving image data or audio data based on the read/write command, and an ADDRESS signal 676 for designating the row address 70 and the column address 71 of the storage cell C.

A case where the CPU 6 that controls the foregoing signals issues a normal read/write command to an arbitrary storage cell C of the DRAM memory 7 is now explained.

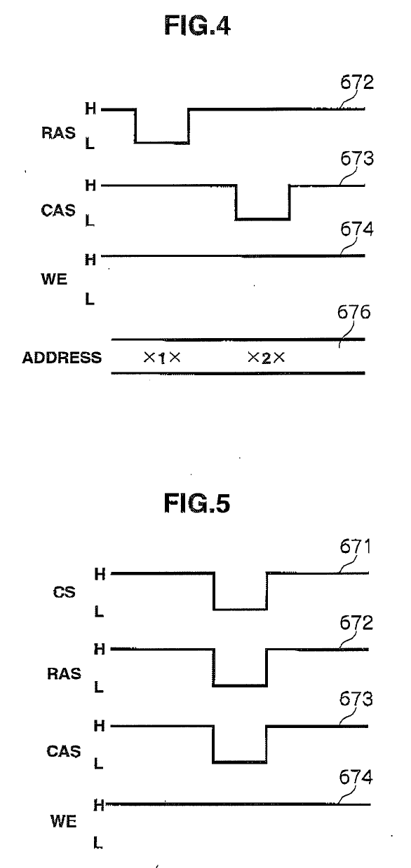

For example, as shown in FIG. 4, the CPU 6 sets the RAS signal 672 to Low and Active at an arbitrary timing, and designates the ADDRESS signal 676 as the row address “1.” In addition, the CPU 6 sets the CAS signal 673 to Low and Active at a timing that does not overlap with the RAS signal 672, and designates the ADDRESS signal 676 as the column address “2.” The CPU 6 thereafter sets the WE signal 674 for issuing a read/write command to High and then issues a read command. In this case, as shown in FIG. 2, a read request has been issued to the storage cell C located at the row address “1” and the column address “2.”

The standard refresh method where the CPU 6 issues an auto refresh command, which is one type of refresh command, to an arbitrary storage cell C of the DRAM memory 7 is now explained.

As shown in FIG. 5, when the CPU 6 sets the CS signal 671, the RAS signal 672 and the CAS signal 673 to Low and sets the We signal 674 to High and issues a read command at the same arbitrary timing, the DRAM memory 7 recognizes this to be an auto refresh command.

When the DRAM memory 7 receives the auto refresh command sent from the CPU 6, that command is accessed by the storage cell C in line units AR, the refresh operation is performed to the storage cell C of that line in the DRAM memory 7, and the charge is replenished thereby.

For example, if the DRAM memory 7 has 8,192 row addresses 70 and the auto refresh command is to be issued in 64 ms intervals, and the auto refresh command is issued 8,192 times in the span of 64 ms, all storage cells C in the DRAM memory 7 can be refreshed and data can be stably retained.

Like this, the CPU 6 controls the DRAM memory 7 based on the foregoing memory control.

### (3) Dummy Read Processing

The dummy read processing, which is a feature of the present invention, is now explained. The dummy read processing is executed by the CPU 6 based on a dummy read program 80.

Foremost, after the power of the information recording/playback apparatus 1 is turned on, the CPU 6 starts the dummy read processing before performing the standard memory access processing (S0).

Subsequently, the CPU 6 determines whether there is an area A in the DRAM memory 7 to be accessed based on the read/write command within a threshold time T (S1).

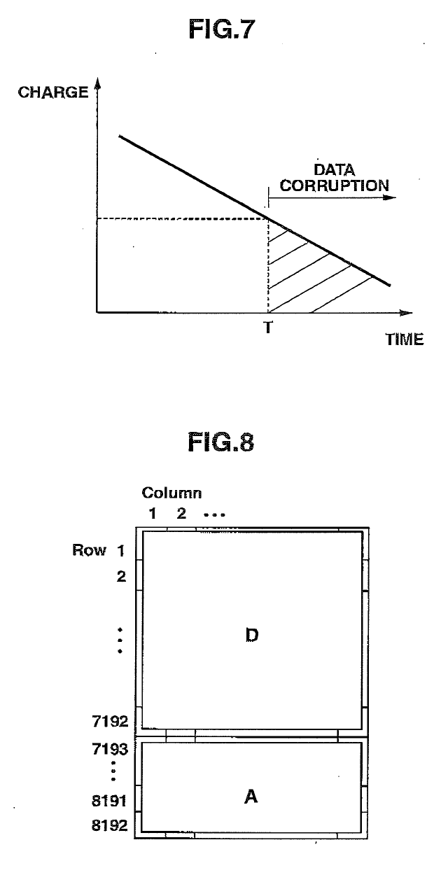

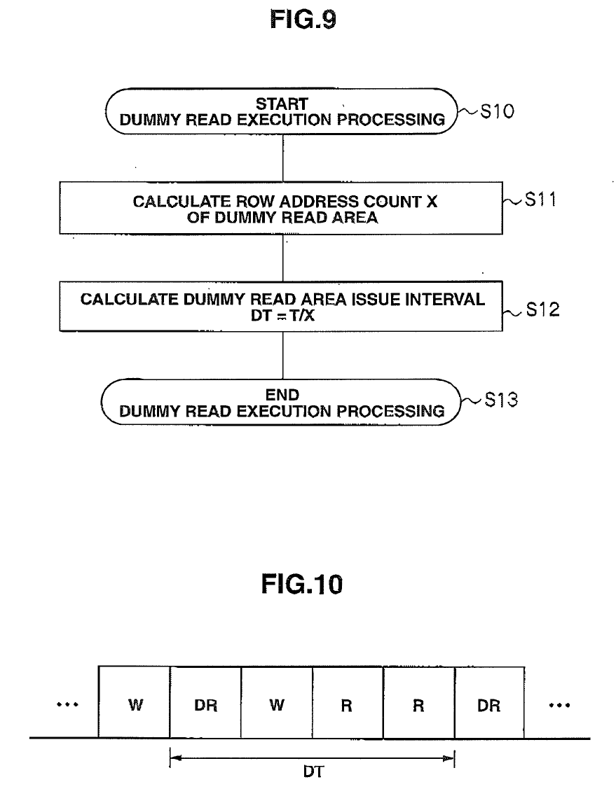

The threshold time T is explained below. FIG. 7 is a graph representing the relationship of the vertical axis showing the charge amount of the capacity and the horizontal axis showing the time regarding the storage of data in the storage cell C. According to this graph, the charge amount decreases and data cannot be stored when the time lapses in the storage cell C. The threshold time T is the issue interval time of issuing a refresh command to the storage cell C under normal circumstances, and is the critical time that the storage cell C can read the correct data without causing data corruption. Thus, so as long as it is within the threshold time T, correct data will be stored in the storage cell C.

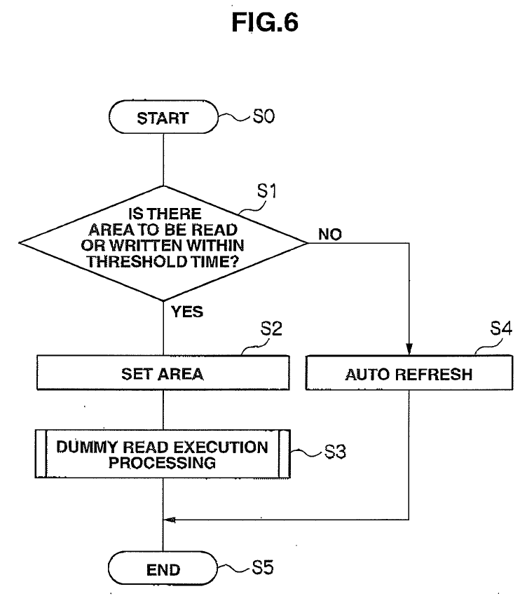

Returning to FIG. 6, when the CPU 6 determines that there is an area A in the DRAM memory 7 to be accessed based on the read/write command within the threshold time T (S1: YES), it sets this area A (S2).

As shown in FIG. 8, for instance, the area A of row addresses 70 from 7193 to 8192 is set as the area in which the read/write command will be accessed within the threshold time T. Here, the area A is set with storage cells in row address units AR to be subject to auto refresh. In this area A, since current will flow as a result of read/write being performed within the threshold time T, the charge will be replenished without having to perform auto refresh.

Although the area A does not required auto refreshing, areas (hereinafter referred to as the “dummy read areas D”) other than the area A are areas that need to be replenished with charge by performing auto refresh under normal circumstances. Nevertheless, if it is possible to simulatively issue a read command to the dummy read areas D and read the stored data, since current will flow in the areas D and charge will be replenished, the same effect as a case of performing auto refresh can be obtained.

Thus, when an area A that does not need to be subject to auto refresh is set, the CPU 6 determines such area to be a dummy read area D, and performs dummy read execution processing to that dummy read area D (S3).

Here, “dummy read” means to simulatively issue a read command to the dummy read area D and read the stored data. The data read based on the dummy read is data that does not need to be read under normal circumstances. The dummy read area D is an area other than the area A, and is an area that is configured from storage cells in row address units. Details concerning the dummy read execution processing will be described later.

When the charge is replenished in the respective storage cells C in the dummy read area D, the CPU 6 ends the dummy read processing (S5),

If the CPU 6 determines that there is no area in the DRAM memory 7 to be accessed based on the read/write command within the threshold time T (S1: NO), it executes auto refresh to the DRAM memory 7 (S4) to replenish the charge, and then ends the dummy read processing (S5).

### (4) Dummy Read Execution Processing

The dummy read execution processing is now explained. The dummy read execution processing, similar to the dummy read processing, is also executed by the CPU 6 based on the dummy read program 80.

Foremost, when the CPU 6 determines that the dummy read area D is an area that needs to be subject to dummy read, it starts the dummy read execution processing (S10).

Subsequently, the CPU 6 calculates the row address count X of the dummy read area D (S11). The row address count X of the dummy read area D is calculated by subtracting the row address count of the area A from the total number of row addresses of the DRAM memory 7.

For example, as shown in FIG. 8, since the total number of row addresses is 8,192 and the row address count of the area A is 1,000 addresses from 7,193 to 8,192, the row address count X of the dummy read area D will be 7,192.

Subsequently, the CPU 6 calculates the issue interval DT for issuing a dummy read command to the dummy read area D. Here, a dummy read command is a command for simulatively reading data that is stored in the dummy read area D and which does not need to be read under normal circumstances, and replenishing the charge in the respective storage cells C configuring that area D. The issue interval DT for issuing the dummy read command is sought by dividing the threshold time T by the row address count X of the dummy read area D.

For example, if the threshold time T is 64 ms and the row address count X of the dummy read area D is 7,192, the issue interval DT will be 8.8 μs. As shown in FIG. 10, when the issue interval DT is calculated, the CPU 6 issues a dummy read command DR every issue interval DT similar to issuing a write command W or a read command R. Incidentally, although this embodiment explains a case of performing dummy read in cycles of dummy read command issue intervals DT, depending on the information recording/playback apparatus, there are cases where dummy read cannot be performed in given cycles. In such a case, this problem can be dealt with by shortening the threshold time T of 64 ms to 60 ms or the like.

As a result of simulatively reading the data stored in the dummy read area D into the information recording/playback apparatus, current will flow in the area D and the charge will be replenished, thereby eliminating the need to perform auto refresh.

### (5) Effect of Present Embodiment

According to the present embodiment, if there are storage cells that can be accessed within the threshold time, by issuing a dummy read command to the areas excluding such storage cells and reading data stored in those areas as dummy data, charge can be replenished in those areas.

Moreover, according to the present embodiment, since charge is replenished by executing dummy read to storage cells that need to be refreshed, it is possible to perform control so that the refresh operation is not performed to arbitrary storage cells that do not need to be refreshed.

According to the present embodiment, it is possible to seek the low power consumption of the information recording/playback apparatus by performing control so that the refresh operation is not performed to arbitrary storage cells that do not need to be refreshed.

The present invention can be broadly applied to memory control circuits or information recording/playback apparatuses including one or more DRAM memories.

What is claimed is:

1. An information recording/playback apparatus comprising a memory for storing data and which includes a plurality of storage cells configured from a capacitor for accumulating charge,
wherein, when an issue interval time for issuing a read/write command to an arbitrary storage cell is shorter than a threshold time for retaining a charge amount for the arbitrary storage cell to read correct data,
a dummy read command for simulatively reading data stored in storage cells other than the arbitrary storage cell is issued to storage cells other than the arbitrary storage cell, and dummy read processing is executed for replenishing charge in the capacitor configuring storage cells other than the arbitrary storage cell.

2. The information recording/playback apparatus according to claim 1,
wherein the dummy read processing replenishes charge in the capacitor configuring storage cells other than the arbitrary storage cell according to an issue interval of the dummy read command calculated based on an address count showing storage cells other than the arbitrary storage cell and the threshold time.

3. The information recording/playback apparatus according to claim 2,
wherein a storage cells are identified from a row address and a column address, and
wherein the address showing storage cells other than the arbitrary storage cell is a row address count obtained by subtracting a row address count of the arbitrary storage cell from the total number of row addresses of a plurality of storage cells configuring the memory.

4. A memory control method of an information recording/playback apparatus comprising a memory for storing data and which includes a plurality of storage cells configured from a capacitor for accumulating charge, comprising:
when an issue interval time for issuing a read/write command to an arbitrary storage cell is shorter than a threshold time for retaining a charge amount for the arbitrary storage cell to read correct data,
a step of issuing a dummy read command for simulatively reading data stored in storage cells other than the arbitrary storage cell to storage cells other than the arbitrary storage cell; and
a step of executing dummy read processing for replenishing charge in the capacitor configuring storage cells other than the arbitrary storage cell.

5. The memory control method according to claim 4,
wherein the step of executing the dummy read processing replenishes charge in the capacitor configuring storage cells other than the arbitrary storage cell according to an issue interval of the dummy read command calculated based on an address count showing storage cells other than the arbitrary storage cell and the threshold time.

6. The memory control method according to claim 5,
wherein a storage cells are identified from a row address and a column address, and
wherein the address showing storage cells other than the arbitrary storage cell is a row address count obtained by subtracting a row address count of the arbitrary storage cell from the total number of row addresses of a plurality of storage cells configuring the memory.
